(19) United States
(12) Patent Application Publication
(10) Pub. No.: US 2012/0158212 A1
(43) Pub. Date: Jun. 21, 2012

(54) INTELLIGENT DATA CENTER BASED ON SERVICE PLATFORM FOR VEHICLE-MOUNTED DEVICES

(75) Inventors: Yilun Ying, Shanghai (CN); Liang Huo, Shanghai (CN); Yu Jiang, Shanghai (CN); Jun Zhu, Shanghai (CN); Shuxin Li, Shanghai (CN); Yong Gao, Shanghai (CN); Dawei Zhu, Shanghai (CN); Yehui Zhang, Shanghai (CN)

(73) Assignees: Shanghai Pateo Internet Technology Service Co., Ltd., Shanghai (CN); Shanghai Pateo Electronic Equipment Manufacturing Co., Ltd., Shanghai (CN)

(21) Appl. No.: 13/392,808

(22) PCT Filed: Dec. 27, 2010
(86) PCT No.: PCT/CN2010/080290

§ 371 Date: Feb. 27, 2012

(30) Foreign Application Priority Data
Dec. 31, 2009 (CN) 200910247994.6

(51) Int. Cl. G06F 17/00; G06F 7/00

(52) U.S. Cl. 701/1; 706/50

(57) ABSTRACT

The present invention provides a intelligent data center based on a service platform for vehicle-mounted devices, including: a static data storage unit, adapted for storing static data relating to a vehicle-mounted device; a static data processing unit, adapted for processing the static data stored in the static data storage unit; a dynamic data storage unit, adapted for storing dynamic data which are relating to the vehicle-mounted device and acquired by the service platform for vehicle-mounted devices; and a data analysis unit, adapted for analyzing the static data and the dynamic data. The intelligent data center can provide a wide variety of services for the vehicle-mounted device through the service platform.

### CROSS REFERENCE TO RELATED APPLICATIONS

The present application claims the priority of Chinese Patent Application No. 200910247994.6, entitled “Intelligent Data Center Based on Service Platform for Vehicle-mounted Devices”, and filed on Dec. 31, 2009, the entire disclosure of which is incorporated herein by reference.

### FIELD OF THE INVENTION

The present invention generally relates to data communication, and more particularly, to an intelligent data center based on a service platform for vehicle-mounted devices.

### BACKGROUND OF THE INVENTION

Recently, with the development of multi-media technology and automobile technology, more and more multi-media applications are required in automobiles. For example, a VCD play system is generally configured in an automobile for playing music and video. And even in some automobiles, GPS systems are configured to recognize the positions of the automobiles and to provide navigation services for the automobiles.

In prior art, a communication platform for vehicle-mounted devices is disclosed for providing services such as navigation, phone-call, fax, and message communication.

However, it is difficult for the conventional communication platform to support diversified multi-media operations, such as real-time downloading of entertainment programs, and inquiring of traffic information, weather information, vehicle use information, and life information. Although, some multi-media operations can be performed by wireless network functions of a cell-phone or a telephone, the multi-media services cost high, and the multi-media operations are complicated, and inconvenient for users, especially those in the automobiles.

### SUMMARY OF THE INVENTION

In order to solve the above problems, embodiments of the present invention provide an intelligent data center based on a service platform for vehicle-mounted devices, including:
A static data storage unit, adapted for storing static data relating to a vehicle-mounted device;
A static data processing unit, adapted for processing the static data stored in the static data storage unit;
A dynamic data storage unit, adapted for storing dynamic data which are relating to the vehicle-mounted device and acquired by the service platform for vehicle-mounted devices; and
A data analysis unit, adapted for analyzing the static data and the dynamic data.

Optionally, the static data storage unit includes:
A user data storage unit, adapted for storing data of a user who enjoys services of the service platform through the vehicle-mounted device; and
A vehicle data storage unit, adapted for storing data of a vehicle relating to the vehicle-mounted device.

Optionally, the static data storage unit further includes:
An information storage unit, in which data stored are used to provide services for the vehicle-mounted device by the service platform.

Optionally, the static data processing unit includes:
A user data processing unit, adapted for processing the user data stored in the user data storage unit; and
A vehicle data processing unit, adapted for processing the vehicle data stored in the vehicle data storage unit.

Optionally, the static data processing unit further includes:
An information processing unit, adapted for processing the data in the information storage unit based on communication between the service platform and the vehicle-mounted device when the service platform provides services to the vehicle-mounted device.

Optionally, the dynamic data storage unit includes:
A vehicle information unit, adapted for storing online information of the vehicle.

Optionally, the online information of the vehicle includes: A driving track and a position of the vehicle in the current moment.

Optionally, the dynamic data storage unit further includes: A user information unit, adapted for storing online information of the user.

Optionally, the online information of the user includes user information recorded by the service platform after the user logs on the service platform.

Compared with the prior art, the embodiments of the present invention have the following advantages.

The intelligent data center can store the static data relating to the vehicle-mounted device, acquire the dynamic data of the vehicle-mounted device provided by the service platform, obtain historical driving information and stop information of the user based on the dynamic information, and predict actions of the user by special scientific computing according to information of websites and the vehicle-mounted device set by the user, thereby providing a wide variety of personalized services for the user through the vehicle-mounted device.

### BRIEF DESCRIPTION OF THE DRAWINGS

FIG. 1 is a schematic view for illustrating a work mode of an intelligent data center based on a service platform for vehicle-mounted devices in an embodiment of the present invention;

FIG. 2 is a schematic view for illustrating a structure of an intelligent data center based on a service platform for vehicle-mounted devices in a first embodiment of the present invention;

FIG. 3 is a schematic view for showing a structure of an intelligent data center based on a service platform for vehicle-mounted devices in a second embodiment of the present invention;

FIG. 4 is a schematic view for showing a structure of an intelligent data center based on a service platform for vehicle-mounted devices in a third embodiment of the present invention; and

FIG. 5 is a schematic view for showing a structure of an intelligent data center based on a service platform for vehicle-mounted devices in a fourth embodiment of the present invention.

### DETAILED DESCRIPTION OF THE EMBODIMENTS

Specific embodiments and examples will be described herein in detail in conjunction with attached drawings for illustrative purposes, but the description of illustrated embodiments is not intended to limit the present invention, and equivalent modifications are possible within the scope of this description, as those skilled in the relevant art will recognize.

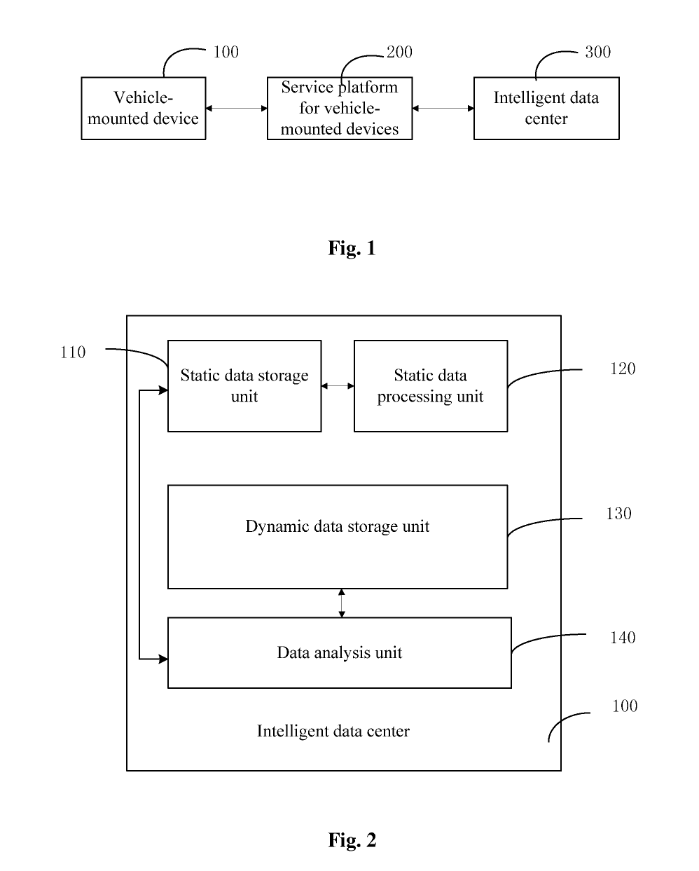

FIG. 1 is a schematic view for illustrating a work mode of an intelligent data center based on a service platform for vehicle-mounted devices in an embodiment of the present invention.

Referring to FIG. 1, a vehicle-mounted device 300 is a terminal device for providing services for a user, so that the user not only can enjoy diverse local services by the vehicle-mounted device 300 in a vehicle, but also can enjoy internet services by connecting the vehicle-mounted 300 with a service platform for vehicle-mounted devices.

A service platform for vehicle-mounted devices 200 may provide a plurality of vehicle-mounted devices 300 connected with the service platform with services, such as driving efficiency services, vehicle use services, driving consumption services, and vehicle-mounted entertainment services.

An intelligent data center 100 is adapted for acquiring static data relating to the vehicle-mounted device 300 and storing the static data. The intelligent data center 100 is also adapted for acquiring dynamic data relating to the vehicle-mounted device 300 from the vehicle-mounted device 300 through the service platform 200. The intelligent data center 100 is also adapted for mining and analyzing the static data and/or the dynamic data, which makes that it is possible to realize the services based on the data mining.

Generally, the service platform 200 may provide services based on internet resources. Besides, the service platform 200 may also provide more services based on the intelligent data center, which may not be provided based on the internet resources, especially personalized services generated based on the data mining and processing of the static data and/or the dynamic data of the vehicle-mounted device or the user.

Specifically, in an embodiment, the service platform 200 may perform the above services based on communication with the intelligent data center 100.

Compared to a networked vehicle-mounted device in the prior art, the intelligent data center 100 can provide the user with the personalized services. In an embodiment, the intelligent data center 100 can not only provide a data downloading service, but also can provide an intelligent downloading service of personalized data according to the user and the preferences of the user.

In order to provide the personalized services, the data stored in the intelligent data center 100 may be divided into general data and personalized data relating to user registration and login. Specifically, the user may be in a log on state or a log off state, and the intelligent data center 100 can acquire the information whether the user is in the log on state. In the log on state, the user can download the data through the service platform according to a user identification. In the log off state, the user can also download data from the service platform, however, the user can only obtain non-personalized data in the log off state. In an example embodiment, in the log on state, the user can obtain personalized news and furthermore, can obtain special information such as vehicle maintenance notices and SIM card fee notices; and in the log off state, the user can only download defaulted news and sports news.

In another example embodiment, it may also be configured in a way that the vehicle-mounted device acquires a download strategy personalized by the user from the service platform when the user is in the log on state. The download strategy will determine a size of a data packet and a downloading frequency in subsequent download processes according to a size of a file to be received, a network state and an order of urgency of demanding an application program.

FIG. 2 is a schematic view for illustrating a structure of an intelligent data center based on a service platform for vehicle-mounted devices in a first embodiment of the present invention. The embodiments of the intelligent data center of the present invention will be described in detail in conjunction with FIG. 2.

The intelligent data center 100 includes: A static data processing unit 110, a static data storage unit 120, a dynamic data storage unit 130 and a data analysis unit 140.

The static data storage unit 120 is adapted for storing static data relating to the vehicle-mounted device, and the static data processing unit 110 is adapted for processing the static data stored in the static data storage unit 110.

The dynamic data storage unit 130 is adapted for storing dynamic data relating to the vehicle-mounted device acquired from the service platform.

The data analysis unit 140 is adapted for analyzing the static data and the dynamic data.

Generally, the static data include the information of the vehicle-mounted device, the information of the vehicle having the vehicle-mounted device, and also the information of the user using the vehicle-mounted device. Based on the storage and processes of the static data, a lot of functions can be provided, such as managing the access authority for the user and the vehicle-mounted device accessing the service platform.

In an embodiment, the intelligent data center may store and process static data which can not be obtained from the internet (such as edited multi-media files), in order to provide more considerate and diversified services for the user. In another embodiment, the static data may also be resources from the internet, which can reduce time and resource taken for searching the data in the internet through the service platform.

In an embodiment, the dynamic data include a driving history of the vehicle having the vehicle-mounted device, an operation information of the user using the vehicle-mounted device, such as a log on/off state information, a vehicle start/stop state information, a driving information (a speed, a direction and a position), an operation information of application sub-modules, and a communication information between the vehicle-mounted device and the service platform.

Multiple services may be obtained by storing and processing the dynamic data, such as providing the vehicle-mounted device with a driving route and information relating to the driving route according to the driving history of the vehicle having the vehicle-mounted device, and providing corresponding information for the user according to the operation of the user.

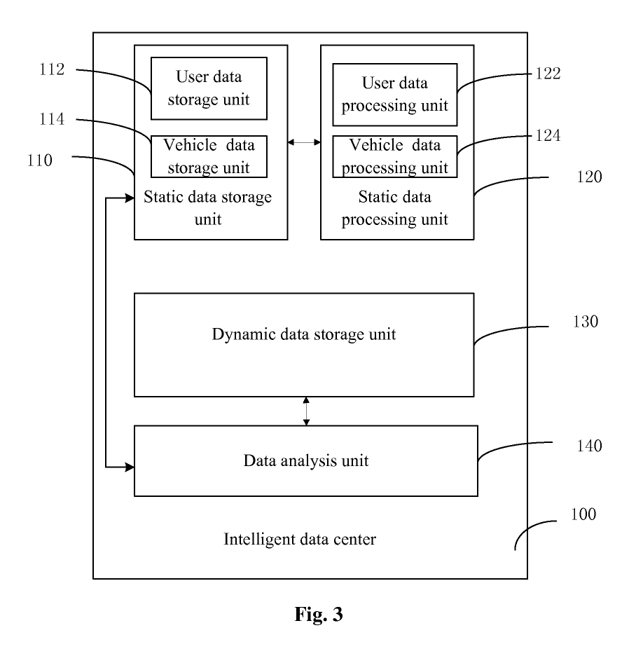

FIG. 3 is a schematic view for showing a structure of an intelligent data center based on a service platform for vehicle-mounted devices in a second embodiment of the present invention. Referring to FIG. 3, the static storage unit 120 includes:
A user data storage unit 122, adapted for storing user data of the user who enjoys services of the service platform through the vehicle-mounted device; and
A vehicle data storage unit 114, adapted for storing vehicle data of the vehicle relating to the vehicle-mounted device.

In an embodiment, the user data may include a user name, a password, information of the owner of the vehicle, and so on. The vehicle data may include vehicle-mounted device serial number, vehicle information, and so on.

In an embodiment, if a user needs the highest management authority, under which the user may inquire and perform a confidential management to the private information relating to the vehicle-mounted device itself or generated while using the services of the service platform, the user would register as the owner of the vehicle rather than a general user. The user data processing unit 122 and/or the vehicle data processing unit 124 may perform a corresponding operation to bond the user registration information with the vehicle-mounted device information (such as the vehicle-mounted device serial numbers) and make a corresponding mark in the user data storage unit 112 and/or the vehicle data storage unit 114.

In another embodiment, the user data processing unit 122 further performs statistics of the user registration information and records the user registration information in the user data storage unit 112. The vehicle data processing unit 124 performs statistics of the vehicle data and records the vehicle data in the vehicle data storage unit 114.

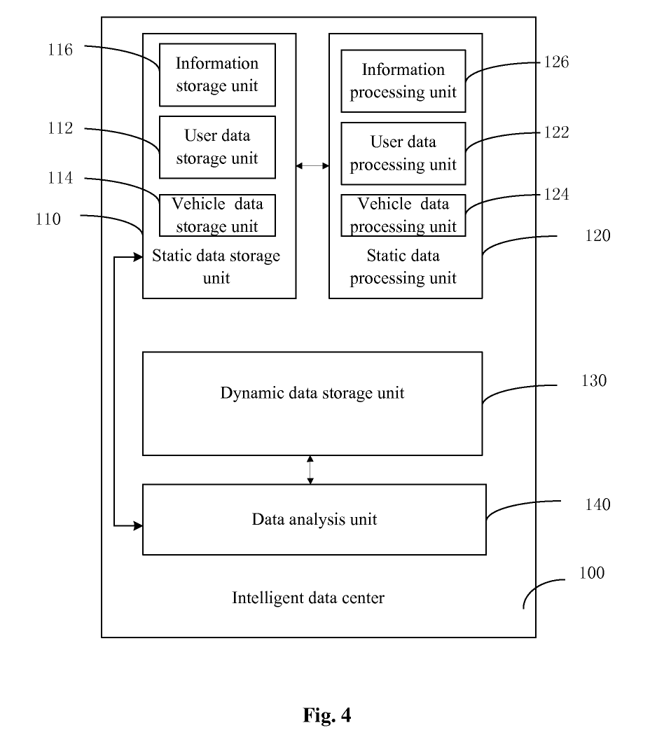

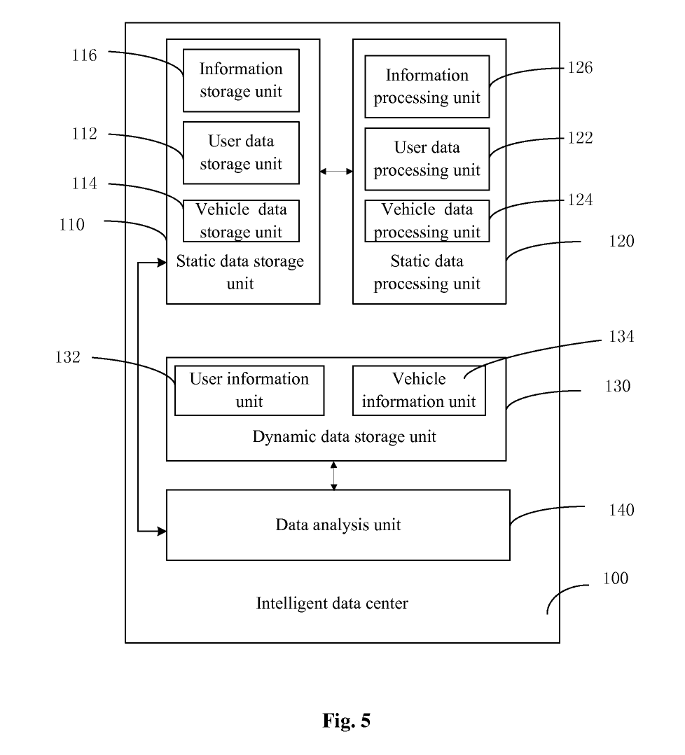

Referring to FIG. 4, in an embodiment, the static data storage unit 120 further includes an information storage unit 116 which is adapted for providing needed data to the vehicle-mounted device from the service platform.

In another embodiment, the static data storage unit 120 further includes an information processing unit 126 which is adapted for processing the data stored in the information storage unit, based on communication between the service platform and the vehicle-mounted device when the service platform provides services to the vehicle-mounted device.

In an example embodiment, the user sends categories of internet resources to be subscribed through the service platform, and the categories of the internet resources are stored in the information storage unit 116, so that the service platform may periodically acquire the categories of the internet resources from the information storage unit 116, and acquire the internet information from the internet according to the categories, and send the internet information to the user. The information processing unit 126 may perform statistics and analysis to the data stored in the information storage unit 116.

In another example embodiment, the service platform 200 may search data from internet or storage devices, obtain the data the user frequently used by analyzing the data, and store the data to the information storage unit 116. For example, the service platform 200 may download MP3 audios from the internet, choose some MP3 audios which are frequently used by the user and store them in the information storage unit 116, so that the service platform 200 may provide the audios from the information storage unit 116 to the vehicle-mounted device if the user needs them.

In another embodiment, the information storage unit 116 may store data not existing in the internet (such as personalized data), and the service platform 200 may acquire the data and provide services for the vehicle-mounted device with cooperation of the information processing unit 126.

Referring to FIG. 5, in an embodiment, the dynamic data storage unit 130 includes: A vehicle information unit 132 which is adapted for storing online information of the vehicle which includes a driving route and a position of the vehicle in the current moment.

In another embodiment, the dynamic data storage unit 130 further includes: A user information unit 134 which is adapted for storing online information of the user.

It should be noted that, in an embodiment, after the vehicle-mounted device is connected with the service platform, the service platform provides the information of the vehicle-mounted device to the vehicle information unit, in order to indicate that the vehicle-mounted device is already on-line. Moreover, the service platform cooperates with the intelligent data center to acquire the dynamic data of the vehicle-mounted device and the vehicle having the vehicle-mounted device.

Generally, after the user logs on the service platform by using the registration information (such as the user name and password), the service platform provides the registration information to the user information unit of the intelligent data center, in order to indicate that the user of the vehicle-mounted device is already on-line. In addition, the service platform cooperates with the intelligent data center to acquire the dynamic data of the user and the information of vehicle having the vehicle-mounted device.

Referring to FIG. 5, in an embodiment, the vehicle information unit 132 may record information of a time and a place at which the vehicle, which is connected with the intelligent data center through the service platform, arrives. The user information unit may record information about a time and a place at which a user arrives. The data analysis unit 140 may analyze the above information, such as may obtain the number of times that the vehicle or the user arrives at the place at that time by statistics.

In another embodiment, the data analysis unit 140 may perform an analysis by combining the static data with the dynamic data. In an example embodiment, the data analysis unit 140 may predict actions of the user by special scientific computing, according to the historical driving information and stop information of the user obtained based on dynamic information, and according to information of websites and the vehicle-mounted device set by the user, thereby providing a wide variety of personalized services for the user through the vehicle-mounted device, such as providing information which best matches the demand of the user, and recommending the best driving destination.

In another embodiment, the data analysis unit 140 may directly analyze the dynamic data. In an example embodiment, the data analysis unit 140 may predict or recommend next step according to a stop place, an average driving speed, and a driving style of the vehicle having the vehicle-mounted device. In another embodiment, the data analysis unit 140 may perform an analysis for the change trend of the dynamic data.

Moreover, a multi-dimensional analysis may be performed in conjunction with the static data of the user. The dimensions for reference include a price sensitivity of the user, an aim of driving (such as for working, traveling), a degree of care for safety, and so on.

Furthermore, except providing prediction and recommendation services, the data analysis unit 140 may provide recommendation services based analysis of the user data. In an example embodiment, there is a big pit in a remote road, which causes speed reduction of the vehicles passing by. Warning information about the situation is not shown in the navigation system in time, and there is not an indication of a traffic jam in the real-time state of the road because there are not too many vehicles passing by. However, the intelligent data center may capture the abnormal situation and provide a warning for vehicles which will drive to the remote road in advance. In other words, the result of the dynamic data analysis may update the static data (map information).

According to the embodiments of the present invention, the intelligent data center can store the static data relating to the vehicle-mounted device, acquire the dynamic data of the vehicle-mounted device provided by the service platform, and analyze the static data and the dynamic data, thereby providing a wide variety of personalized services for the user.

Although the present invention has been disclosed as above with reference to preferred embodiments, it is not intended to limit the present invention. Those skilled in the art may modify and vary the embodiments without departing from the spirit and scope of the present invention. Accordingly, the scope of the present invention shall be defined in the appended claim.

What is claimed is:

1. A intelligent data center based on a service platform for vehicle-mounted devices, comprising:
a static data storage unit, adapted for storing static data relating to a vehicle-mounted device;
a static data processing unit, adapted for processing the static data stored in the static data storage unit;
a dynamic data storage unit, adapted for storing dynamic data which are relating to the vehicle-mounted device and acquired by the service platform for vehicle-mounted devices; and
a data analysis unit, adapted for analyzing the static data and the dynamic data.

2. The intelligent data center according to claim 1, wherein the static data storage unit comprises:
a user data storage unit, adapted for storing data of a user who enjoys services of the service platform through the vehicle-mounted device; and
a vehicle data storage unit, adapted for storing data of a vehicle relating to the vehicle-mounted device.

3. The intelligent data center according to claim 2, wherein the static data storage unit further comprises:
an information storage unit, in which data stored are used to provide services for the vehicle-mounted device by the service platform.

4. The intelligent data center according to claim 2, wherein the static data processing unit comprises:
a user data processing unit, adapted for processing the user data stored in the user data storage unit; and
a vehicle data processing unit, adapted for processing the vehicle data stored in the vehicle data storage unit.

5. The intelligent data center according to claim 4, wherein the static data processing unit further comprises:
an information processing unit, adapted for processing the data in the information storage unit based on communication between the service platform and the vehicle-mounted device when the service platform provides services to the vehicle-mounted device.

6. The intelligent data center according to claim 1, wherein the dynamic data storage unit comprises:
a vehicle information unit, adapted for storing online information of the vehicle.

7. The intelligent data center according to claim 6, wherein the online information of the vehicle comprises: a driving track and a position of the vehicle in the current moment.

8. The intelligent data center according to claim 6, wherein the dynamic data storage unit further comprises: a user information unit, adapted for storing online information of the user.

9. The intelligent data center according to claim 8, wherein the online information of the user comprises user information recorded by the service platform after the user logs on the service platform.
